(19) United States
(12) Patent Application Publication
(10) Pub. No.: US 2015/0037488 A1
(43) Pub. Date: Feb. 5, 2015

(54) METHOD FOR THE PRODUCTION OF AN EXPANDED AND DEHYDRATED PROTEIN FOOD

(71) Applicant: Innovacion Sabor y Control, S.A. De C.V., Monterrey (MX)

(72) Inventor: Sonia CASTILLO-HERNANDEZ, Monterrey (MX)

(73) Assignee: Innovacion Sabor y Control, S.A. De C.V., Monterrey (MX)

(21) Appl. No.: 14/044,495

(22) Filed: Oct. 2, 2013

(30) Foreign Application Priority Data
Aug. 1, 2013 (MX) MX/A/2013/008931

(51) Int. Cl. A23L 1/312; A23L 1/00

(52) U.S. Cl. CPC A23L 1/312; A23L 1/0085; A23V 2002/00
USPC 426/645; 426/447

(57) ABSTRACT

A method for the production of an edible expanded dehydrated protein product which comprise submitting the pork skin pellets to a high temperature and pressure inside a sealed chamber and later to a sudden decompression in order to cause the instantaneous evaporation of the water in the pellet and produce a pork crackling having a fat content very similar to the original pellet, which is substantially lower than in the pork crackling produced by traditional methods.

### BACKGROUND OF THE INVENTION

A. Field of the Invention

The present invention is related to methods for the production of expanded dehydrated protein products and more particularly to a method for the production of pork cracklings comprising submitting pork skin pellets to a high temperature and pressure and subsequently to a sudden decompression in order to achieve the instantaneous evaporation of the water contained in the pellet, thus producing pork cracklings having a low fat content similar to the fat content of the original skin pellet, which is substantially lower than the fat content of pork cracklings produced by traditional methods.

B. Description of the Related Art

The pork has been used for human consumption since humans left the nomad way of life. Under the life conditions prevalent in ancient times, the consumption of pork and derivatives was subject to the lack of proper refrigeration. The urgency of consuming pork was imperative. For this reason, there were developed several conservation methods such as meat fermentation or drying the meat with salt and cooking. Among the methods that were discovered was the drying of the pork skin for its preservation and later consumption.

It is not very clear the history period at which the pork skin was started to be used for producing pork cracklings. However, such product is part of the diet of people of several countries in the world. The pork cracklings are popular in Spain, Argentina, Bolivia, Brazil, Chile, Colombia, Cuba, Republica Dominicana, Ecuador, Guatemala, Honduras, El Salvador, Mexico, Nicaragua, Panama, Peru, Filipinas, Puerto Rico, and other countries.

The traditional method for producing pork cracklings comprises:
a) Pellet production: the pork pellets are produced by the traditional frying method by deep frying the pork skin in lard between 95° C. and 110° C. during a time of approximately 8 hours until it is achieved a water content of between about 5 and 8%. There are several variations of this method, and the main differences between the products obtained by these methods comprise their water content.
b) Production of pork cracklings: once the pork skin pellet is deep fried, it is cooled and is preserved for further processing. For transforming the deep fried pork skin pellets in pork cracklings, the pellet is submerged in lard at 190° C. The water trapped in the collagen protein matrix is converted to vapor and expands the protein structure. It is important to note that as the vapor escapes from the product, the lard takes the water place. Said water-lard interchange gives the product a high fat content. The product fat content is very prone to get spoiled due to the high temperature to which it was submitted. Therefore, this kind of product tends to suffer oxidative rancidity reactions, which is a cause of bad taste in the pork crackling.

During the pork cracklings expansion process, the shape of the product is completely undefined. In fact, the larger the pellet size, the greater will be the deformation of the product. With the traditional process, it is impossible to obtain an uniformly shaped product, and therefore, it is very difficult to pack it in rigid containers having a defined shape, thus forcing the producers to sell the product in bags that are difficult to manipulate at the selling point.

In order to provide the pork cracklings with different flavors, they can be added a particular flavor, but it is important to mention that the flavor can be added only to the surface of the product.

The popularity of this product is limited by the fact that it is highly caloric. The pork crackling has 544 calories per 100 grams and 52% of such calories are from fat. If the fat percentage of the product is higher, the caloric intake may reach 70%. Expressed as percentage, the fat content may represent 31.3% of the product. It should be noted that any variation in the process may cause great variations of the fat content in the product that may range from 30 to 45% of the product. Additionally, a 36% of the fat content of the product, comprises saturated fat. The protein content of the pork cracklings is 61.3%. The rest of the calories are mainly from the protein. Additionally, the consume of pork cracklings as snack, forces the producers to add sodium to the product (in the form of sodium chloride), so that the pork cracklings further contain 1,818 mg of sodium per 100 grams of product.

Therefore, the use of pork cracklings as snack in a healthy diet is restricted to the caloric intake requirement of each person, so that, the amount of product to be consumed must be relatively low.

In view of the above, it would be highly desirable to have a method for the production of pork crackling that do not need lard for the cooking of the pellets, and by which it is produced a food having organoleptic characteristics almost identical to the traditional pork crackling but without the fat, high caloric content and having a high protein content. Additionally if the production method allows standardizing the shape of the product and its composition, it may comprise a great advance in the crackling production methods.

Taking into account the above referred needs, applicant developed a method got the production of cracklings which comprise submitting the pork skin pellets to a high temperature and pressure inside a sealed chamber and later to a sudden decompression in order to cause the instantaneous evaporation of the water in the pellet and produce a pork crackling having a fat content very similar to the original pellet, which is substantially lower than in the pork crackling produced by traditional methods,

Since the pork cracklings produced by the method of the present invention is expanded by means of heat and pressure, when the water is expelled from the product, there is no fat that can take the place of the water, such as in the traditional methods, and therefore the fat content of the final product is substantially lower than the one of the traditional product (less than a 10%).

As the pork crackling produced by the method of the present invention does not contain water, it is basically comprised by fat and protein since the cracklings is expanded without being submerged in a fatty media, so that the final product has higher protein content than the traditional product.

The method of the present invention allows producing pork cracklings in the form of circular toasts which may have a diameter of 12 cm. It is possible to produce the circular toasts having a width of from 1 to 6 mm and its shape may be of an almost perfect circular disc which may be packed in rigid containers, which make them very easy to manipulate in the selling point.

Typically, the toasts (in Mexico) are made of corn. A 25 gr toast, having a fat content of 40%, has 230 calories. If the toast is baked and not fried, its caloric content is 100 calories. A cracklings toast produced by the method of the present invention, is very versatile since it can be used for eating other previously flavored foods, therefore it is not necessary to add sodium chloride to the pellet in order to produce the cracklings toasts.

### SUMMARY OF THE INVENTION

It is therefore a main object of the present invention, to provide a method for the production of an edible expanded dehydrated protein product which comprise submitting the pork skin pellets to a high temperature and pressure inside a sealed chamber and later to a sudden decompression in order to cause the instantaneous evaporation of the water in the pellet and produce a pork crackling having a fat content very similar to the original pellet, which is substantially lower than in the pork crackling produced by traditional methods.

It is another main object of the present invention, to provide a method for the production of an edible expanded dehydrated protein product of the above referred nature, in which the pork cracklings produced by the method of the present invention is expanded by means of heat and pressure, when the water is expelled from the product, there is no fat that can take the place of the water, such as in the traditional methods, and therefore the fat content of the final product is substantially lower than the one of the traditional product (less than a 10%).

It is an additional object of the present invention, to provide a method for the production of an edible expanded dehydrated protein product of the above referred nature, by which it can be produced pork cracklings in the form of circular toasts which may have a diameter of 12 cm.

It is another object of the present invention, to provide a method for the production of an edible expanded dehydrated protein product of the above referred nature by which it can be produced pork cracklings toasts having a width of from 1 to 6 mm and its shape may be of an almost perfect circular disc which may be packed in rigid containers, which make them very easy to manipulate in the selling point.

These and other objects and advantages of the method for the production of an edible expanded dehydrated protein product of the present invention will become apparent to those persons having an ordinary skill in the art, from the following detailed description of the embodiments of the invention.

### DETAILED DESCRIPTION OF THE INVENTION

The method for the production of an edible expanded dehydrated protein product of the present invention will now be described making reference to a preferred embodiment thereof, wherein the method of the present invention uses as raw material, pork skin pellets produced by the traditional frying method of deep frying the pork skin in lard between 95° C. and 110° C. during a time of approximately 8 hours until it is achieved a water content of between about 5 and 8%.

The method of the present invention for the production of an edible expanded dehydrated protein product comprises the steps of:
a) providing a pressure chamber, which, in a preferred embodiment, has a cylindrical shape having a diameter of 7 cm and a width of 0.8 cm and heated by means of electrical resistances, which can be hermetically closed by its superior portion by means of a cylindrical hood that penetrates inside the cavity of the cylinder chamber, approximately 2 mm;
b) introducing the pork skin pellets to the sealed pressure chamber, in which the pork skin pellet has a particle size of between about 2 mm to 4 mm in a minimal amount such that the area of the pellet to be introduced has a size that is equal or greater than the inferior area of the pressure chamber, i.e. the inferior area of the chamber must be totally covered by the pellet;
c) heating the pressure chamber at a temperature of between about 250° C. and 300° C. and maintaining the pork skin pellet inside said chamber during a residence period of between about 5 to 8 seconds, wherein there is a lineal relation between time and temperature in accordance with the lineal equation T=383.3−16.66S wherein T represents the temperature to which the chamber must be heated and S is the residence time in seconds of the pellet inside the chamber. In a preferred embodiment of the invention, the chamber is heated at a temperature of 250° C. and the residence time of the pellet inside the chamber is 8 seconds;
d) opening the hood in an instant way at the end of the residence time period, wherein in a preferred embodiment, the residence time is 8 seconds;
e) removing the product from the pressure chamber which comprise a crispy solid protein matrix having a low water content, better known as pork cracklings.

The product obtained by the method of the present invention, comprise a protein product (pork cracklings), having a high protein content (80%), no carbohydrates and six times less fat that the traditional pork cracklings,

Pork pellets are mainly comprised of collagen. In the traditional process for the production of pellets, the skin is cooked and dehydrated until the protein content is between about 4 and 8%. Since the dehydrating process is carried out submerging the pellet in lard, it can be concluded that the pellet contains the fat transferred from the process. Said fat content may be modified if the production process is modified.

The pellet is volumetrically provided to the pressure chamber. As the temperature of the pellet rises, the water enters the overheating temperature range. The collagen begins to behave like a liquid jelly due to the two following main effects:
1. Physical effect. The temperature of the chamber far exceeds the gelatinization temperature of the collagen (73° C.), therefore, it became in liquid protein with overheated water inside the protein matrix.
2. Chemical effect. The water overheating raises 100 times the hydronium concentration (H3O+) and the hydroxyl concentration (OH−). Such strong acid and strong base effect, solubilizes the collagen protein, in the same way that it occurs in the process for the production of commercial jelly, just that in this case, no acid or strong base has been added.

When the pork skin pellet is heated inside the sealed pressure chamber, the pressure inside thereof, begin to raise due to the water heating contained inside the pellet particles. Said pressure increase causes the water inside the pellet particles to overheat, such that when the heating is concluded, the hood is instantly opened and the accumulated pressure inside the chamber is suddenly liberated, letting the water content of the pellet to escape in form of vapor, thus forming a crispy solid protein matrix having a low water content having a circular toast shape.

### EXAMPLE

An experiment for producing an expanded protein product (pork cracklings toasts) by means of heat and pressure, was carried out. The object of the experiment was to determine the optimum temperature for the production of the pork crackling toasts.

The experiment comprised three treatments (T1, T2 and T3), each defined by the process temperature. T1 had a process temperature of 240° C., T2 had a process temperature of 250° C. and T3 had a process temperature of 260 C. The experiment hypothesis were:

Ho: μ1=μ2=μ3

Ha: μ1≠μ2≠μ3

Each experiment was carried out using 500 grams of pork skin pellets, having a size variability of from 3 to 7 mm. The response variables were weight and product size. Additionally, there were calculated the production performance of each treatment and the amount of complete and incomplete product (pork cracklings toasts).

Raw Material Description.

The samples of pork skin pellets were produced by the traditional frying method by deep frying the pork skin in lard between 95° C. and 110° C. during a time of approximately 8 hours until it is achieved a water content of between about 5 and 8%.

The samples of pork skin pellets were submitted to the treatments by using a cooking chamber. The cooking or pressure chamber comprises a receptacle having a cylindrical shape having a diameter of 7 cm and a width of 0.8 cm. The chamber is made of high carbon steel to resist the temperature and pressure, and it is even resistant to corrosion caused by the superheated water.

The body of the chamber is heated by electric resistances, which can be calibrated at different temperatures. The chamber was closed by its superior portion by means of a cylindrical hood that penetrates inside the cavity of the cylinder chamber, approximately 2 mm.

When closed, the chamber is capable of maintain the pressure caused by the heating of the water contained inside the pork skin particles or pellets. The chamber is feed with 5 gr of the sample for each repetition. The sample is maintained inside the heated chamber during a time of 8 seconds, and when the heating is concluded, the hood is instantaneously opened in such way that the accumulated pressure inside the chamber is suddenly liberated.

Since the water inside the cells is overheated, when the pressure is liberated, the mass of the sample explodes, forming the expanded product. It is worth mentioning that the collagen of the sample is transformed into jelly during the 8 seconds inside the sealed chamber, thus forming a crispy solid protein matrix having a low water content having a circular toast shape.

The feeding of the chamber occurs in a volumetric way, in such way that the processed amount for each iteration of the process, is variable, in accordance with the way the particles accommodate inside the chamber. In a strict sense, the weight of the product is used for determining the variability of the amount of the product that is feed to the chamber. Naturally the fraction of the water that escapes from the chamber at the moment of the explosion is also variable, however, the proximal analysis reveals the change in water content between the sample and the finished product, therefore, it can be discarded such effect, assuming that each explosion comprises an independent but highly replicable event.

The response variables were weight and product diameter. The independent variables were the three described treatments. The data was analyzed using PROC ANOVA de SAS under a totally random balanced model. Both the SAS program as well as the obtained results are shown in the following table:

| | TRT 1 | | | TRT2 | | | TRT3 | | |
|---|---|---|---|---|---|---|---|---|---|
| | WEIGHT | DIAM | CHAR | WEIGHT | DIAM | CHAR | WEIGHT | DIAM | CHAR |
| 1 | 4.5 | 14 | C | 4.3 | 14 | C | 4.4 | 14.7 | C |
| 2 | 4.8 | 13.6 | C | 3.9 | 13.4 | C | 4.1 | 14 | C |
| 3 | 3.8 | 13 | C | 4.4 | 14.2 | C | 4 | 13.9 | C |
| 4 | 4.3 | 13 | C | 4.5 | 14.4 | C | 4.8 | 14.7 | C |
| 5 | 2.2 | 12 | C | 4.4 | 14 | C | 4.8 | 14.4 | C |
| 6 | 2.5 | 12 | C | 4.5 | 14 | C | 4.7 | 14.5 | C |
| 7 | 2.2 | 11.6 | C | 4.6 | 14 | C | 4.7 | 14.7 | C |
| 8 | 5.5 | 13.9 | C | 4.8 | 14.3 | C | 4.2 | 14.7 | C |
| 9 | 4.8 | 13.3 | C | 4.8 | 14.9 | C | 4.7 | 14.4 | C |
| 10 | 3.9 | 13.2 | C | 4.7 | 14.5 | C | 4.4 | 15 | C |
| 11 | 2.3 | 12 | C | 4.5 | 14.2 | C | 4.6 | 14.9 | C |
| 12 | 4.6 | 14 | C | 4.6 | 14.5 | C | 4.3 | 14.9 | C |
| 13 | 4.5 | 13.2 | C | 4.7 | 14.4 | C | 4 | 13.4 | C |
| 14 | 4 | 13.5 | C | 4.5 | 14 | C | 4.7 | 14.3 | C |
| 15 | 2.2 | 11 | C | 4.8 | 13.5 | C | 5 | 14.2 | C |
| 16 | 4.3 | 13 | C | 4.9 | 14.5 | C | 4.6 | 13.3 | C |
| 17 | 2.4 | 12.7 | C | 4.5 | 14 | C | 4.5 | 14.2 | C |
| 18 | 4.4 | 13.4 | C | 4.5 | 14.2 | C | 4.4 | 14.4 | C |
| 19 | 4.6 | 13.6 | C | 4.1 | 14 | C | 4.1 | 14.3 | C |
| 20 | 4.9 | 12.6 | C | 4.5 | 14.5 | C | 4.5 | 14 | C |
| 21 | 3.8 | 13.2 | C | 4.5 | 14 | C | 4.8 | 14.7 | C |
| 22 | 4.2 | 13.1 | C | 4.3 | 14 | C | 5.2 | 15.2 | C |
| 23 | 4.9 | 12.4 | C | 4.1 | 14.2 | C | 4.3 | 14.4 | C |
| 24 | 4.6 | 13.2 | C | 4.3 | 14 | C | 4.2 | 14 | C |
| 25 | 4.6 | 13.1 | C | 4.8 | 14.6 | C | 4.7 | 14.2 | C |
| 26 | 4.4 | 13.4 | C | 4.8 | 14 | C | 5.3 | 14.2 | C |
| 27 | 2.4 | 12.6 | C | 4.5 | 14 | C | 4.7 | 14.7 | C |
| 28 | 4.5 | 13 | C | 4.2 | 14 | C | 4.7 | 14.5 | C |
| 29 | 4.2 | 14 | C | 4.4 | 15 | C | 5 | 14 | C |
| 30 | 5.2 | 13.5 | C | 4.1 | 14 | C | 4.2 | 14.2 | C |
| 31 | 5 | 13 | C | 4.5 | 14.6 | C | 4.4 | 14.6 | C |
| 32 | 4.4 | 13.4 | C | 5 | 13.9 | C | 4 | 13.5 | C |
| 33 | 4.7 | 13 | C | 3.9 | 13.4 | C | 4.4 | 14.6 | C |
| 34 | 4.3 | 13.5 | C | 4.1 | 14.4 | C | 4.3 | 13.5 | C |
| 35 | 3.9 | 13.6 | C | 3.8 | 14 | C | 4.7 | 14 | C |
| 36 | 4.7 | 13.6 | C | 4.5 | 14.7 | C | 4.3 | 14 | C |
| 37 | 4.4 | 14.2 | C | 4.2 | 14 | C | 4.5 | 14.5 | C |
| 38 | 4.9 | 13.7 | C | 4.2 | 14.6 | C | 4.4 | 14.6 | C |
| 39 | 5.2 | 13.5 | C | 3.8 | 13.8 | C | | | |
| 40 | 5.3 | 13 | C | 4.5 | 14.2 | C | | | |
| 41 | 4.8 | 12.4 | C | 4.3 | 14.3 | C | | | |
| 42 | 4.7 | 13.2 | C | 4.2 | 14.4 | C | | | |
| 43 | 4.9 | 12.7 | C | 4.3 | 14.3 | C | | | |
| 44 | 4.2 | 13.5 | C | 4.6 | 13.4 | C | | | |
| 45 | 4.9 | 12.6 | C | 4.2 | 14 | C | | | |
| 46 | 4.7 | 13 | C | 4.3 | 14.9 | C | | | |
| 47 | 4 | 13.6 | C | 3.9 | 13.6 | C | | | |
| 48 | 4.2 | 13 | C | 4.7 | 13.9 | C | | | |
| 49 | 3.2 | 13.5 | C | 4.6 | 14 | C | | | |
| 50 | 5 | 12.4 | C | 4.2 | 14.3 | C | | | |
| 51 | 4.6 | 13.5 | C | 4.9 | 14.5 | C | | | |
| 52 | 4.1 | 13.4 | C | 4.5 | 14.6 | C | | | |
| 53 | 5.2 | 13 | C | 3.5 | 14.3 | C | | | |
| 54 | 3.1 | 13 | C | 4.5 | 14.1 | C | | | |
| 55 | 4.2 | 12.9 | C | 3.9 | 14.1 | C | | | |
| 56 | 3.1 | 11 | C | 4.3 | 14.3 | C | | | |
| 57 | 4.3 | 13.5 | C | 4.2 | 14.4 | C | | | |
| 58 | 4.6 | 13.4 | C | 4.4 | 14.9 | C | | | |
| 59 | 2.4 | 12 | C | 4.5 | 14.5 | C | | | |
| 60 | 4.7 | 13.2 | C | 3.6 | 14.2 | C | | | |
| 61 | 4.1 | 14 | C | 4.2 | 15 | C | | | |
| 62 | 3.5 | 13 | C | 4.8 | 14.5 | C | | | |
| 63 | 2.4 | 10.5 | C | 4.1 | 13.5 | C | | | |
| 64 | | | | 4.3 | 14.6 | C | | | |
| 65 | | | | 4.8 | 14 | C | | | |
| 66 | | | | 4.6 | 14.3 | C | | | |
| 67 | | | | 4.5 | 14.9 | C | | | |
| 68 | | | | 3 | 13.2 | C | | | |
| 69 | | | | 4.3 | 14.6 | C | | | |
| 70 | | | | 5.2 | 14.4 | C | | | |
| 71 | | | | 3.6 | 13.6 | C | | | |
| 72 | | | | 4.1 | 14.1 | C | | | |
| 73 | | | | 4.4 | 15 | C | | | |
| 74 | | | | 4 | 14.1 | C | | | |
| 75 | | | | 4.5 | 15 | C | | | |
| 76 | | | | 4.6 | 14.1 | C | | | |
| 77 | | | | 4.8 | 14.4 | C | | | |
| | 261.2 | 13.03 | | 336.4 | 14.22 | | 171.6 | 13.28 | |
| | | 63 | | | 77 | | | 41 | |
| 1 | 5.1 | 12 | I | 3.9 | 14 | I | 3.2 | 13 | I |
| 2 | 5.1 | 13 | I | 4.3 | 14.5 | I | 3.8 | 13.7 | I |
| 3 | 5.1 | 14 | I | 4.6 | 14.4 | I | 4.6 | 14.3 | I |
| 4 | 4.9 | 12.5 | I | 4.1 | 14.3 | I | 3.9 | 13.7 | I |
| 5 | 2.7 | 12 | I | 4.4 | 13.5 | I | 4.5 | 14.5 | I |
| 6 | 4 | 13 | I | 4.1 | 13.9 | I | 4 | 14 | I |
| 7 | 4.3 | 13.3 | I | 4.2 | 14.5 | I | 4.3 | 14.5 | I |
| 8 | 1.9 | 12 | I | 4.6 | 13.6 | I | 4.2 | 14.2 | I |
| 9 | 1.8 | 10 | I | 4.6 | 13.4 | I | 4 | 14.3 | I |
| 10 | 2.1 | 10.4 | I | 4 | 14.2 | I | 4.3 | 14 | I |
| 11 | 5.3 | 13 | I | 4.1 | 14.9 | I | 4.1 | 14.2 | I |
| 12 | 4.8 | 14 | I | 2.5 | 12.4 | I | 4.3 | 14.5 | I |
| 13 | 3.4 | 13.4 | I | 4.2 | 14.1 | I | 4.3 | 14.3 | I |
| 14 | 4.1 | 13.5 | I | 4.1 | 14.4 | I | 4.6 | 14.2 | I |
| 15 | 4.1 | 13 | I | 4 | 14.5 | I | 5 | 15.2 | I |
| 16 | 4.4 | 13 | I | 2.9 | 13.8 | I | 4.5 | 14.6 | I |
| 17 | 4.5 | 13.6 | I | 4.2 | 14.9 | I | 4.4 | 14.6 | I |
| 18 | 4 | 13.5 | I | 4.5 | 14.9 | I | 4.6 | 14.7 | I |
| 19 | 2.8 | 12 | I | 5.2 | 14 | I | 4.2 | 14 | I |
| 20 | 2.2 | 12.2 | I | 3.9 | 14 | I | 4.6 | 14.7 | I |
| 21 | 2 | 12 | I | 4.7 | 14.8 | I | 4.1 | 13.6 | I |
| 22 | 5.4 | 13 | I | 4.4 | 14 | I | 4.6 | 14.8 | I |
| 23 | 3.9 | 13.5 | I | 4.1 | 14.5 | I | 4.3 | 14.6 | I |
| 24 | 5.2 | 12.5 | I | 4.2 | 14.8 | I | 4.8 | 14.3 | I |
| 25 | 4.8 | 13.5 | I | 4.3 | 14.3 | I | 4.9 | 14 | I |
| 26 | 4.8 | 14 | I | 4.6 | 14.6 | I | 4.2 | 14.4 | I |
| 27 | 2.9 | 12.5 | I | | | | 4.6 | 14.7 | I |
| 28 | 2.4 | 12 | I | | | | 4 | 14.5 | I |
| 29 | 4.3 | 12.7 | I | | | | 4.3 | 14.3 | I |
| 30 | 3.9 | 13.9 | I | | | | 4.8 | 14 | I |
| 31 | 2.9 | 14 | I | | | | 4 | 14.1 | I |
| 32 | 5.6 | 11.6 | I | | | | 4.1 | 14.3 | I |
| 33 | 4.3 | 12.6 | I | | | | 4.6 | 14.4 | I |
| 34 | 1.5 | 11.3 | I | | | | 4.3 | 14.2 | I |
| 35 | 2.1 | 12 | I | | | | 4.6 | 14.5 | I |
| 36 | 4.4 | 13.6 | I | | | | 4.4 | 14.6 | I |
| 37 | 1.7 | 11 | I | | | | 3.9 | 14 | I |
| 38 | 2.4 | 12 | I | | | | 4.9 | 14.3 | I |
| 39 | 1.9 | 10.6 | I | | | | 4 | 14.2 | I |
| 40 | 2.7 | 12.7 | I | | | | 4.3 | 14.2 | I |
| 41 | 4.6 | 13.4 | I | | | | 4 | 14.2 | I |
| 42 | | | | | | | 4 | 14 | I |
| 43 | | | | | | | 4.1 | 14.5 | I |
| 44 | | | | | | | 4.2 | 14.4 | I |
| 45 | | | | | | | 4.4 | 14.6 | I |
| 46 | | | | | | | 3.8 | 13.6 | I |
| 47 | | | | | | | 4.4 | 14.3 | I |
| 48 | | | | | | | 4.8 | 15.3 | I |
| 49 | | | | | | | 3.6 | 14.2 | I |
| 50 | | | | | | | 4.3 | 14.5 | I |
| 51 | | | | | | | 4.3 | 14 | I |
| 52 | | | | | | | 4.8 | 14.6 | I |
| 53 | | | | | | | 4.5 | 14.7 | I |
| 54 | | | | | | | 4.4 | 14.7 | I |
| 55 | | | | | | | 4.1 | 14.4 | I |
| 56 | | | | | | | 4.8 | 14.6 | I |
| 57 | | | | | | | 3.7 | 14 | I |
| 58 | | | | | | | 3.8 | 13.3 | I |
| 59 | | | | | | | 5 | 15.3 | I |
| 60 | | | | | | | 4.1 | 13.2 | I |
| 61 | | | | | | | 4.3 | 14.6 | I |
| 62 | | | | | | | 4.2 | 14 | I |
| 63 | | | | | | | 4.5 | 14.5 | I |
| 64 | | | | | | | 4.6 | 15 | I |
| 65 | | | | | | | 4.1 | 14 | I |
| 66 | | | | | | | 4.3 | 14 | I |
| Incomplete | 150.3 | 12.63 | | 108.7 | 14.20 | | 284.2 | 14.30 | |
| | | 41 | | | 26 | | | 66 | |
| | | 39% | | | 25% | | | 62% | |
| Complete | 261.2 | 13.03 | | 336.4 | 14.22 | | 171.6 | 13.28 | |
| | | 63 | | | 77 | | | 41 | |
| | | 61% | | | 75% | | | 38% | |
| Total | 411.5 | 104 | | 445.1 | 103 | | 455.8 | 107 | |
| Original | 500 | | | 500 | | | 500 | | |
| Decrease | 88.5 | | | 54.9 | | | 44.2 | | |
| % Decrease | 17.7% | | | 12.3% | | | 9.7% | | |

Other Experiments

Once the main experiment was carried out, there have been derived from said experiment variations in order to determine:
The influence of the particle size of the pellet in the size and weight of the product.
The effect of the content of the water content of the pellets in the characteristics of the product.

Results and Discussion.

The variance analysis of the weight data, gives the necessary results for rejecting Ho: μ1=μ2=μ3. There is a highly significant difference (p<0.0001) between the product weight results. The Duncan average comparison shows that the weight of the product of the treatment TRT3 and of the TRT2 didn't have a significant difference, with values of 4.38 and 4.32 grams respectively. However, the average value of the TRT1 was significantly less (3.95 g) than the other treatments.

On the other hand, the diameter data analysis gives sufficient reliability to reject Ho: μ1=μ2=μ3. The difference was significantly high (p<0.0001) between the results of the diameter of the toast. The Duncan comparison shows that TRT2 and TRT3 do not show significant differences in diameter, with 14.31 and 14.21 respectively. The average for TRT1 was significantly lower than TRT2 and TRT3.

The TRT1 (240° C.) does not provide the correct conditions for forming a regular shaped toast. Additionally, of 500 g of processed sample, only 411.5 g resulted as toast, which is calculated as a process decrease of 88.5 g, i.e. a 17.7%. The TRT2 obtained a decrease of 54.9 g (12.3%) and TRT3 obtained a decrease of 44.2 g (9.7%).

With regard to the percentage of complete toasts versus incomplete toasts, TRT1 obtained 61% of completed toast (c) and 39% of incomplete toasts (I), TRT2 75% C and 25% I and TRT3 obtained 38% C and 62% I. The total number of toasts of each treatment was 104, 103, and 107, respectively for TRT1, 2 and 3. In addition to the treatments above referred, it was tested a temperature above 270° C., however it is important to note that under the set time, the toasts obtained have a burned appearance. Below 240° C., the toasts do not expand.

With regard to the results and to the discussion of other qualitative experiments that were carried out, it was found the following:
The size of the pellet particles influences the size and weight of the toasts.
The dimension of the particles benefits the uniformity result of the toast, because the sample feed occurs in a volumetric way.

However, when the particles are inferior to 1 mm, the material stops flowing, causing plugging of the chamber sample feeding means. It is important to note that the density of the toast is considerably increased when the particle size is lowered from 7 to 2 mm.

Effect of the Water Content of the Pellets on the Final Product Characteristics.

Better expansion results were obtained with samples having a water content of near 8%. When the sample has very low water content, the expansion of the product is difficult.

The temperature of the chamber has a significant influence in the product result. The ideal temperature for expanding the pork cracklings must be of between about 250 and 260° C. The pellet particle size must be near 2 mm and the recommended water content must be close to 8%.

1. A method for the production of an expanded edible protein product comprising the steps of:
a) providing a pressure chamber having an internal cavity with an inferior surface.
b) introducing a pellet of protein material to the internal cavity of the pressure chamber in a minimal amount such that the area of the pellet to be introduced has a size that is equal or greater than the inferior area of the pressure chamber, and then sealing the pressure chamber internal cavity by means of a hood.
c) heating the pressure chamber at a temperature of between 250° C. to 300° C. and maintaining the pellet inside the heated pressure chamber for a period of time of between about 5 seconds for a temperature of 300° C. and 8 seconds for a temperature of 250° C.;
d) opening the hood in an instant way at the end of the time period;
d) removing the product from the pressure chamber which comprise a crispy solid protein matrix.

2. A method for the production of an expanded edible protein product as claimed in claim 1, wherein the pellet of protein material, comprises pork skin pellets having a particle size of between 2 mm to 4 mm.

3. A method for the production of an expanded edible protein product as claimed in claim 1, wherein the pellet of protein material, comprises pork skin pellets produced by deep frying the pork skin in lard between 95° C. and 110° C. during a time of approximately 8 hours until it is achieved a water content of between about 5 and 8%.

4. A method for the production of an expanded edible protein product as claimed in claim 1, wherein the pressure chamber having a cylindrical shape having a diameter of 7 cm and a width of 0.8 cm and heated by means of electrical resistances, which can be hermetically closed by its superior portion by means of a cylindrical hood that penetrates inside the cavity of the cylinder chamber, approximately 2 mm.

5. A method for the production of an expanded edible protein product as claimed in claim 1, wherein in step c), there is a lineal relation between time and temperature in accordance with the lineal equation T=383.3−16.66S wherein T represents the temperature to which the chamber must be heated and S is the residence time in seconds of the pellet inside the chamber.

6. An expanded edible protein product having a protein content of 80% and a carbohydrate content of 0%.

7. An expanded edible protein product as claimed in claim 1, prepared from pork skin.

8. An expanded edible protein product as claimed in claim 1, prepared from pork skin pellets having a particle size of from between about 2 mm to 4 mm.
